(19) United States
(12) Patent Application Publication
(10) Pub. No.: US 2012/0105003 A1
(43) Pub. Date: May 3, 2012

(54) Charging of Electric Vehicles Off the Electric Power Grid

(76) Inventor: Lisa Mae Laughner, Indianapolis, IN (US)

(21) Appl. No.: 13/284,914

(22) Filed: Oct. 30, 2011

Related U.S. Application Data
(60) Provisional application No. 61/409,169, filed on Nov. 2, 2010.
(60) Provisional application No. 61/409,175, filed on Nov. 2, 2010.

(51) Int. Cl. H02J 7/00

(52) U.S. Cl. 320/109; 320/137

(57) ABSTRACT

A system and method are disclosed that provide electric power to one or more electric vehicles without drawing electricity from the electric power grid. The system may include a combustion engine coupled to an electric generator, a controls box coupled to the generator to transmit electricity to an electric vehicle, a building, the electric power grid, or storage batteries.

### RELATED APPLICATIONS

This application claims priority from U.S. Provisional Application Nos. 61/409,169 (filed Nov. 2, 2010) and 61/409,175 (filed Nov. 2, 2010), the disclosures of which are incorporated by reference.

### BACKGROUND

The present disclosure generally relates to charging of electric vehicles off the electric power grid.

The charging of electric vehicles at a residence may involve drawing electricity from the electric power grid through a 220 volt docking station that couples to the electric vehicle via an electric vehicle industry standard connector or by a 110 volt standard plug “trickle charge.” Public charging stations for electric vehicles, which also draw electricity from the electric power grid, provide 220 volt charging to electric vehicles. Fast charging using 480 volts and converting to DC may be available in the future.

The problem with charging electric vehicles by using electricity provided by the power grid is the significant load demand it places on the grid. The electric power grid is publically known to be fragile and subject to blackouts or brownouts. To manage the electric vehicle charging demand, electric vehicle manufacturers and electric utilities are recommending that vehicles be charged at night when electricity demand is at its lowest. However, it has been reported that even as few as two or three electric vehicles “plugged” in at night could cause blackouts as the neighborhood transformers break down from the high electric load demands. Charging electric vehicles during the day, when electricity demand is at its peak, puts tremendous strain on the electric power grid, potentially causing blackouts and also requiring utilities to produce additional power supply at peak load pricing to the consumer.

Electric utilities are faced with a major upgrade to the grid to accommodate the future power demand from electric vehicles. It has been estimated that an upgrade to the USA power grid could be as high as $900 billion to ensure reliable power for charging electric vehicles day or night. This investment is a significant problem for utilities and also consumers who eventually pay for power grid infrastructure through their utility bills.

The charging of electric vehicles at a residence may also involve drawing electricity from solar panels located at the user's residence. The problem with this arrangement is the high capital investment needed to install the solar panels, the inability of the solar panels to generate electricity at night, and the undue length of time needed to generate enough electricity required by electric vehicles.

What is needed is an electric vehicle charging solution that provides efficient and reliable electric power for electric vehicles without drawing power from the power grid.

### SUMMARY

One exemplary embodiment of the disclosed subject matter is a novel electric vehicle charging solution that does not draw power from the electric power grid, thereby eliminating the threat of blackouts, peak load pricing, and the need for an electric power grid upgrade due to electric vehicle charging demand. The present invention provides reliable and environmentally friendly electric power to one or more electric vehicles in a convenient manner to the vehicle owner(s). Moreover, the system of the present invention may couple to the power grid and provide power back to the grid, to a vehicle owner's residence, to a building, or to a bank of storage batteries, thus relieving some of the load demand on the electric power grid.

The present invention includes a method and a system designed to provide electric power to one or more electric vehicles, without drawing electricity from the electric power grid, whether the electric vehicle is at the owner's residence, office, or other building or public location. The system is capable of supplying power to one or more electric vehicles, and alternatively to storage battery packs, a residence/building, or to the electric power grid. The system includes a fuel source, a combustion engine coupled to an electric generator, a controls box, one or more coupling adapters that connect to electric vehicles, and optional storage batteries. The fuel source may include natural gas or alternatively LP gas, propane, diesel, or gasoline. The fuel source may be supplied by a gas utility or a storage tank. The electric generator may be capable of providing 110 volt, 220 volt, or 480 volt single phase or three phase electric power at 50 hertz or 60 hertz frequency. The controls box is capable of commanding various power levels from the generator. The controls box includes hardware and software such as timers, switches, breakers, and electronics that start and stop the system, communicate with the electric vehicle's power system electronics, convert the power from AC to DC or DC to AC, and transmits electric power to the electric vehicle, or the residence/building, or the electric power grid, or the storage batteries. The controls box also contains hardware and software that accommodate the public purchase of the electricity produced by the power system in a public charging station embodiment. The controls box also has the optional capability to connect to the electric power grid and transmit power from the grid to the electric vehicle.

The present invention reliably provides electric power to an electric vehicle without drawing electricity from the power grid. Moreover, when the method of electric generation includes a natural gas fuel source, the generation of said electricity is environmentally friendly because the system produces substantially less carbon dioxide and other pollutants than the same amount of electricity produced from a coal-fired utility.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a block diagram of an embodiment of the disclosed subject matter illustrating a system for charging electric vehicles at a residence or building; and

FIG. 2 is a block diagram of an embodiment of the disclosed subject matter illustrating a public charging system for electric vehicles.

### DETAILED DESCRIPTION

A general problem with charging electric vehicles by using electricity provided by the power grid is the significant load demand it places on the grid. A general solution is to charge electric vehicles without using electricity provided by the grid.

A technical problem in the field of charging electric vehicles is providing reliable and environmentally friendly electric power to one or more electric vehicles in a convenient manner to the vehicle owner(s). A technical solution includes a method and a system designed to provide electric power to one or more electric vehicles, without drawing electricity from the electric power grid. The system may include a fuel source, a combustion engine coupled to an electric generator, a controls box, one or more coupling adapters that connect to electric vehicles, and optional storage batteries.

A general nonlimiting overview of practicing the present disclosure is presented below. The overview outlines exemplary practice of embodiments of the present disclosure, providing a constructive basis for variant and/or alternative and/or divergent embodiments, some of which are subsequently described.

The present invention includes a method and a system for providing electric power to an electric vehicle. The system generates its own electric power and provides that power to the electric vehicle. The system may also provide its generated electric power back to the electric power grid or may provide power the electric vehicle owner's residence or to storage batteries. Because the system avoids the need to draw electricity from the electric power grid, it does not put demand strain on the electric power grid, leading to blackouts or brownouts. Moreover, the system can provide power back to the electric power grid, thus relieving the demand on the electric power grid. Additionally, the system can draw power from the grid if the owner opts to connect to the grid for power.

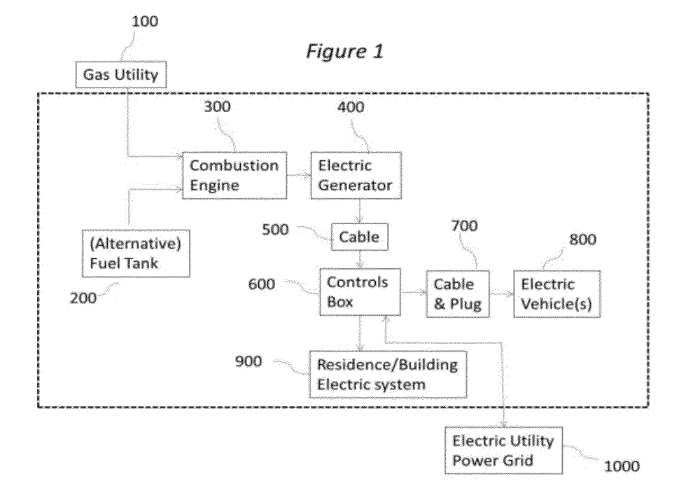

As illustrated in FIG. 1, the system of the present invention may be installed at an electric vehicle owner's residence or other building. The system may comprise a fuel source, such as natural gas delivered by a natural gas utility 100, or alternatively a fuel tank 200. Alternative fuels may be LP gas, propane, diesel fuel, or gasoline. The fuel source provides the fuel to the combustion engine 300, which is coupled to an electric generator 400 via a coupling shaft. The size of the combustion engine 300 and electric generator 400 varies depending on the desired rate of electric power charging for the electric vehicle 800. The electric generator 400 is capable of producing 110 volt or 220 volt AC electricity at 50 hertz or 60 hertz frequency. The electricity generated is transmitted to the controls box 600 via a cable 500. The controls box 600 performs the functions of starting and stopping the system, communicating with the electric vehicle 800, and optionally switching the power so it is available to the electric power grid 1000 or the residence/building 900. The controls box 600 connects to a cable and plug 700 that connects to the electric vehicle 800 and transmits the electricity that charges the electric vehicle's batteries. The controls box 600 may include a 110 volt receptacle, a 220 volt receptacle, and a transfer switch (not shown) that interfaces with the residence/building 900 electric power wiring system. This interface allows the power system to be alternatively used as an electric power source for the residence/building 900. The controls box 600 contains hardware and software (not shown) that allows communication with the electric vehicle 800, the electric generator 400, and combustion engine 300. The controls box 600 contains electronics (not shown) that allow the owner to program the start and stop time of the charging and the rate of power to be provided to the electric vehicle. The controls box 600 may be powered by small batteries such as “D,” “C,” “A,” “AA,” or “AAA” commercially available batteries. Alternatively, the controls box 600 may contain hardware and software (not shown) that allow for communication with the residence/building 900 electric system or electric power grid 1000, including circuit breakers, transfer switches, safety devices and/or circuits, voltage limiters, and monitoring or measuring devices. Furthermore, the controls box 600 may contain electronics (not shown) that allow the option to connect to the electric power grid and provide grid power to the electric vehicle.

In operation, the electric vehicle owner programs the controls box 600 with regard to when to charge the electric vehicle 800, and the owner then connects the electric vehicle 800 to the controls box via cable and plug 700. At the programmed time, the controls box 600 signals the combustion engine 300 to start operating. A valve or other flow control device (not shown) opens the connection to the fuel source (gas line 100 or tank 200) and the combustion engine 300 ignites and begins to operate. The combustion engine 300 output shaft is coupled to the electric generator 400 and rotates, causing the electric generator 400 to produce electricity. The electricity is transmitted to the controls box 600 via a cable 500, and the controls box 600 then transmits the electricity to the electric vehicle 800 via cable 700. Alternatively, the electric vehicle owner may transfer switch the electric power for use by the residence/building 900, or the owner may transfer switch the power to the electric power grid 1000. Alternatively, the owner may program the controls box to connect to the electric power grid instead of the power system, and at the programmed time the controls box transmits electricity from the electric power grid to the electric vehicle.

The electricity-generating components of the system (fuel source 100 or 200, combustion engine 300, and generator 400) may be installed outside the residence or building, or alternatively may be installed inside the residence or building with provisions made for venting of the combustion engine 300 exhaust emissions.

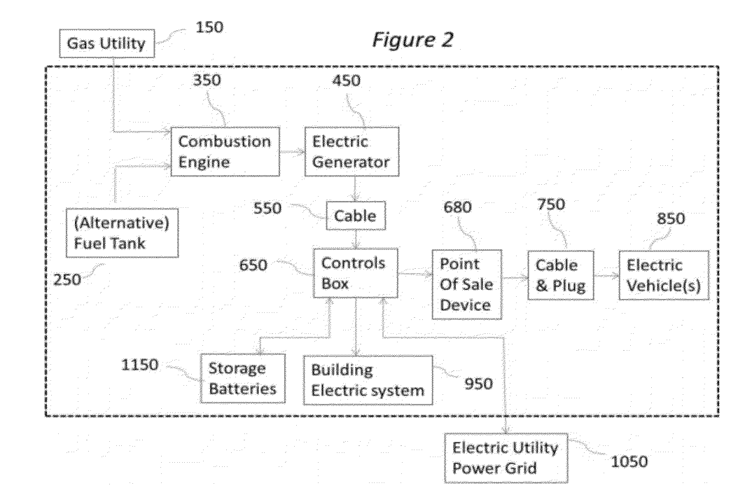

In another embodiment illustrated in FIG. 2, the system of the present invention is installed in a public location for use by the public to charge their electric vehicles. Such a system may comprise a fuel source, such as natural gas delivered by a natural gas utility 150 or alternatively a fuel tank 250. Alternative fuels may be LP gas, propane, diesel fuel, or gasoline. The fuel source provides the fuel to the combustion engine 350, which is coupled to an electric generator 450 via a coupling shaft. The size of the combustion engine 350 and electric generator 450 varies depending on the amount of electric power required by the electric vehicle(s) 850. The electric generator 450 is capable of producing 110 volt, 220 volt, or 480 volt single phase or three phase AC electricity at 50 hertz or 60 hertz frequency. The electricity generated is transmitted to the controls box 650 via a cable 550. The controls box 650 may perform the functions of starting and stopping the system, communicating with the electric vehicle(s) 850, conditioning and transmitting AC or DC power to the electric vehicle, and optionally switching the power to be made available to the electric power grid 1050 or a building 950 or conditioning the power and transmitting it to storage batteries 1150. The controls box 650 includes power electronics (not shown) and one or more cables and plugs 750 that connect to the electric vehicles to transmit the electricity that charges the electric vehicle's batteries. The controls box 650 may include power electronics and transfer switches (not shown) that interface to a bank of storage batteries 1150 or a building's 950 electric power wiring system or the electric power grid 1050. This interface allows the system to be alternatively used as an electric power source for a building 950 or allows the system to store electric power in the batteries 1150 or provide power back to the power grid 1050. The controls box 650 contains hardware and software (not shown) that allow communication with the electric vehicle(s) 850 and communication with the electric generator 450 and combustion engine 350. Alternatively, the controls box 650 may contain hardware and software (not shown) that allow for communication with a building 950 electric system or electric power grid 1050, including circuit breakers, transfer switches, safety devices and/or circuits, voltage limiters, and monitoring or measuring devices. The controls box 650 may contain point of sale hardware and software 680 that allow for credit or debit card transactions to accommodate the sale of the generated electricity to the electric vehicle owner.

In operation, the electric vehicle owner swipes a credit or debit card in a card reader integrated in the point of sale device 680, selects the amount of electricity to be provided to the electric vehicle 850, and connects the cable 750 to the electric vehicle 850. The controls box 650 signals the combustion engine 350 to start operating. A valve or other flow control device (not shown) opens the connection to the fuel source (gas line 150 or tank 250) and the combustion engine 350 ignites and begins to operate. The combustion engine's output shaft is coupled to the electric generator 450 and rotates, causing the electric generator to produce electricity. The electricity is transmitted to controls box 650 via a cable 550 that transmits the electricity to the electric vehicle via cable 750. Once the desired amount of electric power has been delivered to the electric vehicle 850, the electric vehicle owner disconnects the cable 750 and the point of sale transaction completes between the vehicle owner's credit card and the owner of the public charging system. Alternatively, the controls box 650 may signal the storage batteries 1050 to provide the electric power for the electric vehicle 850. Alternatively, the controls box 650 may be programmed to transmit the generated electricity to the electric power grid 1050.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A system for charging electric vehicles off the electric power grid, the system comprising:
an engine;
an electric generator coupled to the engine; and
a controls box in communication with the electric generator and a vehicle, wherein the controls box is configured to supply electricity to the vehicle.

2. The system according to claim 1 wherein the controls box is also in communication with an electric power grid for supplying electricity to the grid.

3. The system according to claim 2 wherein the controls box is also in communication with an electric system of a residence or building.

4. The system according to claim 3 wherein the controls box is also in communication with storage batteries to condition and supply electricity to the storage batteries.

5. The system according to claim 3 wherein the controls box is also in communication with a point of sale device configured to accommodate credit and debit card purchases of electricity.

6. The system according to claim 1 wherein the electric generator is a three phase generator capable of providing varying voltage outputs.

7. The system according to claim 1 wherein the controls box includes hardware and software to condition electric power before being transmitted to the vehicle.

8. A method for charging electric vehicles off the electric power grid, the method comprising:
employing an engine powered by a fuel source;
coupling the engine to an electric generator to generate electricity; and
coupling a controls box in communication with the electric generator and a vehicle, wherein the controls box is configured to supply electricity to the vehicle.

9. The method according to claim 8 wherein the controls box is also in communication with an electric power grid for supplying electricity to the grid.

10. The method according to claim 9 wherein the controls box is also in communication with an electric system of a residence or building.

11. The method according to claim 8 wherein the controls box is also in communication with storage batteries to supply electricity to the storage batteries.

12. The method according to claim 8 wherein the controls box is also in communication with a point of sale device configured to accommodate credit and debit card purchases of electricity.

13. The method according to claim 8 wherein the electric generator is a three phase generator capable of providing varying voltage outputs.
